(19) United States
(12) Patent Application Publication
(10) Pub. No.: US 2005/0112316 A1
(43) Pub. Date: May 26, 2005

(54) Carpet tiles for use on exterior surfaces

(75) Inventor: Lawrence J. O'Connor, Venice, FL (US)

Correspondence Address: PILLSBURY WINTHROP, LLP, P.O. BOX 10500, MCLEAN, VA, 22102, US

(73) Assignee: O'CONNONR INVESTMETN CORP., Winnipeg (CA)

(21) Appl. No.: 11/023,413

(22) Filed: Dec. 29, 2004

Related U.S. Application Data
(63) Continuation-in-part of application No. 10/880,607, filed on Jul. 1, 2004.
Application No. 10/880,607 is a continuation-in-part of application No. 10/821,202, filed on Apr. 9, 2004.
Application No. 10/880,607 is a continuation-in-part of application No. 10/715,562, filed on Nov. 19, 2003.
(60) Provisional application No. 60/630,345, filed on Nov. 24, 2004.
(60) Provisional application No. 60/536,711, filed on Jan. 16, 2004.
(60) Provisional application No. 60/491,292, filed on Jul. 31, 2003.

(51) Int. Cl. B32B 9/00

(52) U.S. Cl. 428/40.1; 428/95

(57) ABSTRACT

A covering is provided for exterior application on solid surfaces such as patios, docks, and walkways. The covering is formed as tiles formed of a top layer of fibrous material, such as carpet, and a bottom layer of adhesive applied at a basis weight of between 185-1000 gsm. The adhesive layer may have beads formed on the edges that function as integral gaskets. The beads on adjacent tiles work together to form sealed seams throughout the installation. A release sheet, preferably formed of plural pieces, is secured over the adhesive for removal during installation. A portion of the release sheet can function as a positioning strip.

### CROSS REFERENCE TO RELATED APPLICATIONS

This application claims priority from U.S. Provisional Application Ser. No. 60/630,345 filed Nov. 24, 2004. This application is a continuation-in-part application of U.S. application Ser. No. 10/880,607 filed Jul. 1, 2004, pending. U.S. application Ser. No. 10/880,607 is (1) a continuation-in-part of U.S. application Ser. No. 10/821,202 filed Apr. 9, 2004 and pending, which claims priority from U.S. Provisional Application Ser. No. 60/536,711 filed Jan. 16, 2004, and (2) a continuation-in-part of U.S. application Ser. No. 10/715,562 filed Nov. 19, 2003 and pending, which claims priority from U.S. Provisional Application Ser. No. 60/491,292 filed Jul. 31, 2003. The contents of these applications are incorporated herein by reference.

### STATEMENT REGARDING FEDERALLY SPONSORED RESEARCH OR DEVELOPMENT

[Not Applicable]

### REFERENCE TO A SEQUENCE LISTING

[Not Applicable]

### BACKGROUND OF THE INVENTION

1. Field of the Invention

This invention relates to surface coverings for exterior use. In particular, this invention relates to fibrous coverings used on exterior solid surfaces, particularly on concrete, such as patios or walkways.

2. Discussion of Related Art

It is known to provide coverings, such as indoor/outdoor carpet, on walkways or patios to provide traction on potentially slippery surfaces and to cover unsightly surfaces. Due to the difficulty in affixing coverings to exterior surfaces that are irregular and exposed to the elements, most coverings are merely laid over the surface or tacked in place.

There is a need for a covering product that is easy to install, is highly durable and can remain securely fastened in place.

### BRIEF SUMMARY OF THE INVENTION

Aspects of embodiments of the invention relate to a product that provides a durable covering for exterior surfaces.

Another aspect of embodiments of the invention relates to a product that is easy to install and remains securely fastened to an underlying surface.

An additional aspect of embodiments of the invention relates to product that may be efficiently packaged for transport, storage and display.

This invention is directed to fibrous covering for outdoor use having an adhesive coating on the underside for permanent adhesion to an exterior surface. The exterior surface can be a solid surface, such as a concrete patio, walkway, driveway or garage floor. It is contemplated that this covering can be applied to most solid exterior surfaces, also including wood.

The covering may have a release sheet removably affixed to the adhesive underside for easy installation on site. Preferably, plural release sheets are used so that one section of the release sheet can be removed initially to provide an initial tack surface to locate and position the covering prior to fully adhering the covering in place.

One aspect of the invention is directed to a covering to be installed on an exterior surface, comprising a fibrous layer having a top fibrous surface, a bottom surface and a plurality of edges, an adhesive layer applied to the bottom surface of the fibrous layer, wherein the adhesive layer includes integral gaskets formed on at least two opposed edges, and a release sheet removably secured to the adhesive layer.

The fibrous layer may include a mix of low melt polyethylene fibers dispersed within polypropylene fibers.

The adhesive may be a pressure sensitive adhesive.

The adhesive may be applied at a basis weight of between 185-1000 gsm. Preferably, the adhesive is applied at a basis weight of between 300-1000 gsm.

The adhesive may applied at a thickness of between 5-30 mils. Preferably, the adhesive is applied at a thickness of between 15-30 mils.

The integral gaskets may be beads of adhesive protruding from the adhesive layer.

The release sheet may cover substantially the entire adhesive layer. More preferably, the release sheet is formed as plural release sheets with one release sheet functioning as a position locator prior to full adhesion of the carpet piece.

The covering may be a tile. The invention may further comprise a plurality of tiles assembled directly adjacent to each other. The integral gaskets on one tile will interact with an adjacent tile to form a watertight seam between tiles.

Another aspect of the invention is directed to a carpet tile for outdoor use, comprising a carpet layer having a top fibrous surface and a bottom surface and including a main portion and an edge portion, an adhesive layer applied to substantially the entire bottom surface of the carpet layer at a basis weight of between 185-1000 gsm, and plural release sheets removably secured to the adhesive layer. The plural release sheets include a main release sheet and a positioning release sheet that is initially removable to form a strip of exposed adhesive to tack the carpet tile in place prior to full adhesion of the carpet tile.

These and other aspects of the invention will become apparent when taken in conjunction with the detailed description and appended drawings.

### BRIEF DESCRIPTION OF THE DRAWINGS

The invention will now be described in conjunction with the accompanying drawings in which:

FIG. 1 is a top view of a plurality of carpet pieces in accordance with the invention installed on a surface;

FIG. 2 is an enlarged side view in cross section of the carpet piece of FIG. 3 taken along line I-I;

FIG. 3 is a bottom view of a single carpet piece prior to installation with the release sheets in place;

FIG. 4A is a top view of a single carpet piece, such as the piece shown in FIG. 2, prior to installation;

FIG. 4B is a top view of a single carpet piece to be installed adjacent to the piece shown in FIG. 4A, prior to installation;

FIG. 5 is a side view in partial section of two adjacent installed carpet pieces; and

FIG. 6 is an enlarged side view in section of circle II of FIG. 5.

In the drawings, like reference numerals indicate corresponding parts in the different figures.

### DETAILED DESCRIPTION OF PREFERRED EMBODIMENTS

This invention is directed to a surface covering in the form of tiles, particularly suited for covering a solid exterior surface, such as a patio, walkway, or dock in an exterior environment or an environment subject to exposure to the elements. The invention is particularly suited for covering large expanses of exterior solid surfaces or surfaces subject to the elements or harsh conditions, even including basement or factory floors.

The tiles in accordance with the invention are particularly suited for connection to surfaces formed of concrete, which can be finished or unfinished. Such surface can range from smooth to rough depending on the finish technique and wear. The invention may also be used on other exterior surfaces including asphalt, synthetic composites, wooden boards, and plastic or plastic composite boards.

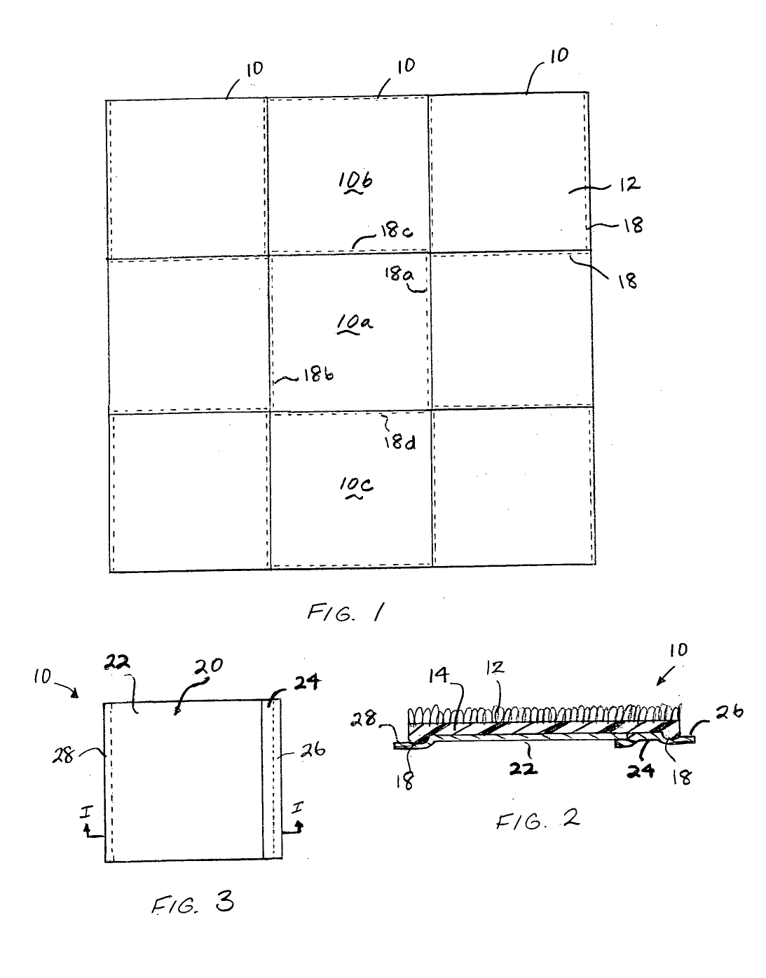

Referring to FIG. 1, the covering in this form of the invention includes a plurality of carpet pieces 10 that are applied to an exterior surface to form a solid covering. Each carpet piece 10 is formed as a tile that can be permanently affixed to an underlying exterior surface. The tile may be any size or shape. The tile may be in the form of a mat, for example a door mat. In one preferred configuration, the tiles are 12 inches by 12 inches.

FIG. 2 shows an enlarged view of carpet piece 10 prior to installation. Carpet piece 10 has a top layer 12 preferably made of a fibrous material, such as carpet material, which provides a surface with good traction and appearance. A desirable weight of fibers would fall within the range 18-60 ounces per square yard. One useful weight for exterior high traffic areas is 28 ounces per square yard.

Preferably, the carpet material is formed as a mix of low melt polyethylene fibers dispersed within polypropylene carpet fibers. The dispersal of these fibers results in a firmer, more stable structure. Due to the improved structure, it is not necessary to use a backing, such as latex as is commonly used. The problem with latex backings in a wet environment is that the foaming agent used during manufacturing becomes reactivated when wet, which causes the material to become slippery. UV treated fibers may be included in the mix to provide protection to the piece 10 in installations exposed to sunlight.

The underside of the top layer 12 is coated with a thick layer of adhesive 14. Preferably, the adhesive 14 is coated directly onto the backside of the top layer 12 of fibrous material to form an integral structure. However, if desired an incompressible layer that can withstand exposure to the elements can be used. Suitable materials for an intermediate layer include foil or EVA film. These materials would provide a tensile strength or barrier layer if desired in the particular design. It is preferred that the back of layer 12 not be formed of a foam backing layer or a porous material, as is common in interior carpeting, as this tends to become water logged and would disintegrate upon exposure to the elements.

The adhesive 14 is preferably water insoluble to resist deterioration due to the elements. The adhesive 14 is preferably made of a pressure sensitive adhesive (PSA) that is a hot melt, meaning it is applied at 100% solids. Suitable adhesive compositions are available from many different manufacturers and can be used as a hot melt adhesive. The application techniques can vary depending on the particular adhesive composition, but one effective method is for the adhesive to be die coated and, if desired, treated with pressure and/or vacuum to enhance physical penetration of the fibrous top layer 12. Other suitable methods known to those of ordinary skill in the art are also possible, such as spraying, extrusion, or other methods of coating. It is preferred that hydrophobic adhesive be used to prevent water contaminating the bond between the adhesive and underlying surface.

The viscosity of the adhesive material 14 may also be varied to affect penetration or wetting into the surface 16, as seen in FIGS. 5 and 6. Lowering the viscosity, increases the wetability (tack) of the adhesive, thereby allowing it to penetrate deeper into the surface 16. As would be appreciated by those of ordinary skill with adhesives, the density of the adhesive will affect the coating weight. The adhesive material 14 functions as a waterproof layer based on its composition and/or thickness. It is preferred that the material be free of voids.

As noted above, in this invention, the adhesive 14 is applied as a thick layer. The minimum thickness of the adhesive 14 measured to its bottom surface is preferably at least 5 mils so as to provide sufficient thickness of adhesive material to obtain complete coverage to allow molding of the carpet piece 10 to the exposed surface 16. The range of preferred thickness of the adhesive 14 is between about 5 mils and 30 mils, more preferably 15 mils-30 mils. Another method of measuring the adhesive is the applied basis weight, coating weight or amount, as the thickness can vary depending upon application techniques The preferred coating weight or amount of adhesive material is at least about 185 gsm, preferably in a range of approximately 185-1000 gsm. Other suitable ranges have been found to be 300-660 gsm, but for application to concrete it is often desirable to coat up to 1000 gsm. These values are based on use of a PSA.

It is contemplated that with different adhesive materials, application techniques, and environments that different volumes, coating weights, or amounts could be successfully used as long as the material has the ability to mold to the underlying irregular surface to form a permanent bond. For example, it is contemplated that a coating weight of about 100 gsm given the appropriate material could be used, especially in climates that do not experience freeze/thaw cycles.

As a result of the thickness and viscosity, the adhesive 14 also conforms to the surface and forms a mechanical interlock with the underlying surface. This interlock creates a permanent bond that stands up to the exterior elements and forms a very secure bond. This is particularly applicable when used on traditional exterior structural elements such as concrete and wood, which have irregular or non-smooth surfaces. On such surfaces, if the adhesive layer is thin moisture can penetrate between the adhesive and the surface comprising the connection. Using a thick layer creates the mechanical connection that prevents moisture from penetrating and ensures a secure connection that will be highly durable. As this invention is particularly suited for use on concrete, the thickness of the adhesive is preferred to be at the high end of the range of 1000 gsm to interlock with various surface textures and voids that occur in concrete. For example, the concrete surface 16 may be finished or unfinished, which tends to be very rough. The thick layer of adhesive 14 will maintain its waterproof characteristics even on unfinished concrete when applied as a thick layer described above.

As seen in FIG. 2, the adhesive layer 14 can be provided with a side bead 18 that functions as an integral gasket on at least one of the edges. For the shape of the tile shown, it is preferred that opposed edges have beads 18 for reasons explained below. As seen in FIGS. 5 and 6, when the piece 10 is pressed onto the surface 16, the bead 18 will tend to flatten and act as a gasket ensuring that no moisture can penetrate the edges of the seal, especially between pieces 10. The bead 18 also ensures that the adhesive layer 14 coats the top layer 12 to the edge when flattened. Although during installation, adjacent tiles 10 will be placed directly in contact with the neighboring tile, slight gaps between tiles will inevitably occur as shown. The beads 18 conform outwardly and directly contact the adhesive 14 of the next tile 10. This forms a solid expanse of adhesive 14 across the underlying surface 16 and ensures that the installation is watertight. Preventing moisture from penetrating under the tiles 10 can ensure that the covering remains affixed across the surface 16 and provides a durable coating for a long period of time.

Providing beads 18 on opposed edges allows a unique installation advantage. Typically, carpet tiles are installed so the pile or direction of the fibers alternate for a more pleasing appearance. In accordance with this invention, the tiles 10 are installed with the pile in alternating directions, which also alternates the sides on which the beads 18 are formed. By this, each tile 10 has the advantage of a beaded edge, two of the beads 18 are carried on that tile and the other two sides of the tile are bounded by a beaded edge of adjacent tiles. This can be appreciated by the configuration shown in FIG. 1. See beads 18a and 18b on interior tile 10a, bead 18c on tile 10b, and bead 18d on tile 10c. As the beads 18 will flatten and spread to the adjacent tile 10, each seam between tiles becomes sealed, as shown in FIG. 6.

Of course, carpet pieces 10 may be formed without beaded edges and still effect a secure seal due to the properties of the adhesive 16 applied at a large basis weight. Alternatively, it may be desirable to add beads to different edges or all edges depending on the shape of the piece or intended installation.

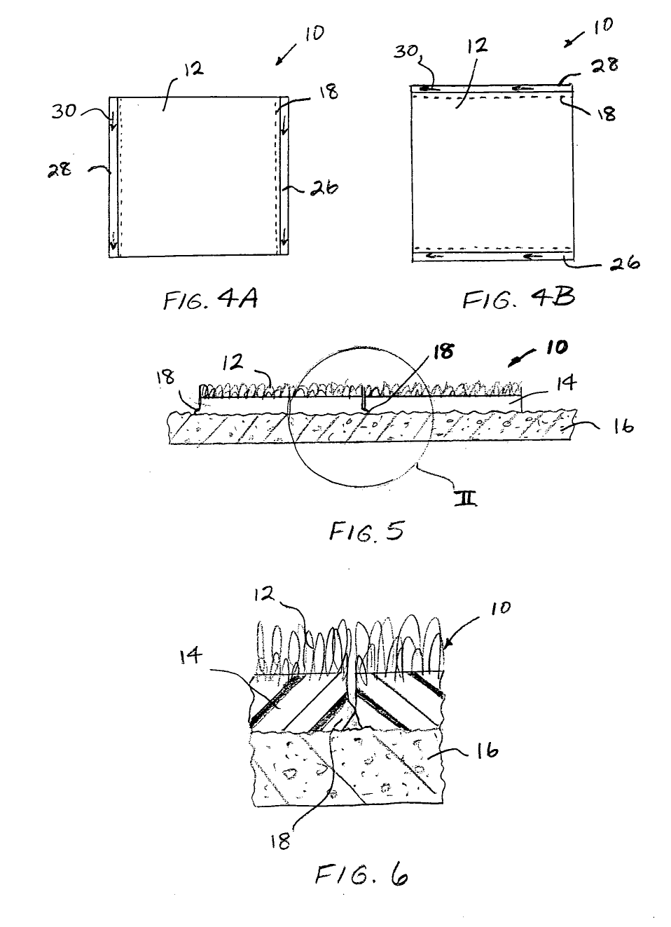

The bottom of the adhesive 16 is covered by a release sheet 20 that is removable upon installation, shown in FIGS. 2, 3, 4A, and 4B. The release sheet 20 is preferably formed as plural sheets, including, for example, a main sheet 22 and a positioning sheet 24. The positioning sheet 24 can be removed first to function as a positioning guide using the thin strip of exposed adhesive to locate and tack the tile 10 in place prior to full adhesion. Of course, the sheets 22 and 24 can be any relative sizes or even a single sheet. The sheets 22, 24 can be placed over the adhesive 14 side by side or in an overlapping relationship, as seen in FIG. 2. Preferably, the sheet 20 has an edge 26, 28 that extends outwardly from at least one side of the tile 10 to act as a gripping flange so that the installer can grasp the edge to peel the sheet(s) 22, 24 away during installation. The edges 26, 28 can carry indicia 30 or instructions for installation. For example, the indicia 30 can indicate the direction of the pile or edge with the bead 18 so that the tiles 10 can be placed in the alternating configuration shown in FIG. 1 to effect fully sealed seams.

The release sheet 20 is removed during installation and discarded. The release sheet 20, which is also called a release liner, can be formed of any releasable sheet material that is easily pulled from the bottom surface of the adhesive 14. A suitable material is silicone coated polyester film. However, other materials may be used, including films such as high density polyethylene, polypropylene, polyolefin, or silicon coated paper. A preferred material is a silicone coated polyester sheet about 1-2 mils thick. The important features of the sheet 20 are that it releases reliably from the adhesive surface and avoids tearing so that it is easy for an installer to use.

When packaged, it is preferred that the pieces 10 are also alternated so that the sides of the tiles 10 that do not have the release sheet overlapping edge 26, 28 are not aligned within a stack. As the these sides have exposed adhesive edges it is desirable to space them apart with the release sheet edges 26, 28 to avoid inadvertent sticking between stacked tiles 10.

Various modifications can be made in my invention as described herein, and many different embodiments of the device and method can be made while remaining within the spirit and scope of the invention as defined in the claims without departing from such spirit and scope. It is intended that all matter contained in the accompanying specification shall be interpreted as illustrative only and not in a limiting sense.

1. A covering to be installed on an exterior surface, comprising:
a fibrous layer having a top fibrous surface, a bottom surface and a plurality of edges;
an adhesive layer applied to the bottom surface of the fibrous layer, wherein the adhesive layer includes an integral gasket formed on at least one edge; and
a release sheet removably secured to the adhesive layer.

2. The covering of claim 1, wherein the fibrous layer includes a mix of low melt polyethylene fibers dispersed within polypropylene fibers.

3. The covering of claim 1, wherein the adhesive layer is a pressure sensitive adhesive.

4. The covering of claim 1, wherein the adhesive layer is applied at a basis weight of between 185-1000 gsm.

5. The covering of claim 1, wherein the adhesive layer is applied at a basis weight of between 300-1000 gsm.

6. The covering of claim 1, wherein the adhesive layer is applied at a thickness of between 5-30 mils.

7. The covering of claim 1, wherein the adhesive layer is applied at a thickness of between 15-30 mils.

8. The covering of claim 1, wherein the integral gasket is a bead of adhesive protruding from the adhesive layer.

9. The covering of claim 1, wherein the release sheet covers substantially the entire adhesive layer.

10. The covering of claim 1, wherein the release sheet is formed as a main release sheet and a positioning release sheet to be removed before the main release sheet to expose a strip of adhesive for positioning the covering prior to full adhesion.

11. The covering of claim 1, wherein the covering is a tile.

12. The covering of claim 1, wherein the integral gasket is formed on two opposed edges.

13. The covering of claim 12, further comprising a plurality of tiles, assembled directly adjacent to each other, wherein the integral gaskets of one tile interact with an adjacent tile to form a watertight seam between each of the tiles.

14. A carpet tile for outdoor use, comprising:
a carpet layer having a top fibrous surface and a bottom surface and including a main portion and an edge portion;
an adhesive layer applied to substantially the entire bottom surface of the carpet layer at a basis weight of between 185-1000 gsm; and
plural release sheets removably secured to the adhesive layer, including a main release sheet and a positioning release sheet that is initially removable to form a strip of exposed adhesive to tack the carpet tile in place prior to full adhesion of the carpet tile.

15. The carpet tile of claim 14, wherein the carpet layer includes a mix of low melt polyethylene fibers dispersed within polypropylene fibers.

16. The carpet tile of claim 14, wherein the adhesive layer is formed of a pressure sensitive adhesive.

17. The carpet tile of claim 14, wherein the adhesive layer is applied at a basis weight of between about 300 and 1000 gsm.

18. The carpet tile of claim 14, wherein the adhesive layer is formed with a bead adjacent opposed edges of the fibrous layer.

19. The carpet tile of claim 18, wherein the bead is an integral gasket that connects with adjacent tiles to form a watertight seam between adjacent carpet tiles.
